(19) United States
(12) Patent Application Publication
(10) Pub. No.: US 2010/0151180 A1
(43) Pub. Date: Jun. 17, 2010

(54) MULTI-LAYER FLUOROPOLYMER FILM

(76) Inventors: David J. Bravet, Shrewsbury, MA (US); Paul W. Ortiz, Wayne, NJ (US)

Correspondence Address: Fulbright & Jaworski L. L. P.;ATTN MNIPDOCKET_SAINT GOBAIN CERAMICS AND PLASTICS, 600 Congress Avenue, Suite 2400, Austin, TX, 78701, US

(21) Appl. No.: 12/576,733

(22) Filed: Oct. 9, 2009

Related U.S. Application Data
(60) Provisional application No. 61/104,893, filed on Oct. 13, 2008.

(51) Int. Cl. B32B 27/08; B32B 9/04; B32B 27/32; B32B 27/38; B32B 27/36; B32B 27/34; B32B 27/00; B32B 27/30; B32B 15/02; B32B 15/08; B32B 27/40; B32B 1/06; B05D 1/36; B05D 3/04; B29C 47/06; B29C 71/04

(52) U.S. Cl. 428/76; 428/411.1; 428/523; 428/413; 428/704; 428/480; 428/474.4; 428/412; 428/473.5; 428/522; 428/500; 428/447; 428/521; 428/421; 428/422; 428/458; 428/461; 428/462; 428/463; 428/457; 428/450; 428/418; 428/477.7; 428/702; 428/516; 428/517; 428/518; 428/519; 428/520; 428/483; 428/474.7; 428/475.2; 428/476.3; 428/476.9; 428/423.1; 428/425.8; 428/425.9; 428/423.5; 428/423.7; 428/424.4; 428/424.8; 428/425.5; 428/424.2; 427/407.1; 427/535; 264/173.16; 264/469

(57) ABSTRACT

The invention describes a carbon black particulate filled film, useful as a backsheet for a photovoltaic construct.

### CROSS REFERENCE TO RELATED APPLICATIONS

This application claims priority and benefit of U.S. Provisional Ser. No. 61/104,893, entitled “Multi-Layer Fluoropolymer Film”, filed Oct. 13, 2008, the contents of which are incorporated in their entirety herein by reference for all purposes.

### FIELD OF THE INVENTION

The invention relates generally to films and multilayer films having at least a material embedded into the film, such as carbon black, that is reactive to a charged particle surface treatment process, and methods for their manufacture that are useful as packaging materials.

### BACKGROUND OF THE INVENTION

Multilayer films or laminates are constructions which attempt to incorporate the properties of dissimilar materials in order to provide an improved performance versus the materials separately. Such properties include barrier resistance to elements such as water, cut-through resistance, weathering resistance and/or electrical insulation. Up until the present invention, such laminates often result in a mis-balance of properties, are expensive, or difficult to handle or process. In particular applications, such as in a photovoltaic back sheet, good interlayer adhesion is needed. In addition, the inner layers may not be fully durable over the life of the laminate without additional protection.

Sophisticated equipment in the electrical and electronic fields requires that the components of the various pieces of equipment be protected from the effects of moisture and the like. For example, photovoltaic cells and solar panels comprising photovoltaic cells must be protected from the elements, especially moisture, which can negatively impact the function of the cells or the conduction of the electricity generated. In addition, circuit boards used in relatively complicated pieces of equipment such as computers, televisions, radios, telephones, and other electronic devices should be protected from the effects of moisture. In the past, solutions to the problem of moisture utilized metal foils as a vapor or moisture barrier. Metal foils if present in the laminate, however, must be insulated from the electronic component to avoid interfering with performance. Previous laminates using metal foils typically displayed a lower level of dielectric strength than was desirable, while other laminates using a metal foil layer were also susceptible to other environmental conditions.

Thin multi-layer films are useful in many applications, particularly where the properties of one layer of the multi-layer film complement the properties of another layer, providing the multi-layer film with properties or qualities that cannot be obtained in a single layer film. Previous multi-layer films generally provided only one of the two qualities desirable for multi-layer films for use in electronic devices.

A need therefore remains, in particular, for a multi-layer film that provides a well bonded fluoropolymer back sheet that can protect a photovoltaic device. Additionally, what is desired is a bondable fluoropolymer layer that can be used within a combined back sheet, or can serve as a complete backsheet.

### BRIEF SUMMARY OF THE INVENTION

The present invention provides films and multilayer films that can be prepared by melt processing methods known in the art, such as coextrusion, as well as coating and casting methods. One important aspect of the invention is that there is at least one layer that includes a polymeric matrix material and a particulate filler material that is reactive to a charged particle process as noted herein. The multilayer films then, can include additional layers that surround this layer with the filler material that can be further treated to effect desirable surface characteristics, such as adhesive properties.

The present invention surprisingly provides a bondable fluoropolymer layer that can be used within a combined back sheet, or can serve as a complete backsheet.

The present invention provides that for certain protective covering applications, such as the backsheet of a photovoltaic device, it is desirable to modify the color, opacity or reflectance of the laminate. This can now be done for aesthetic appearance, to block harmful UV light, to capture reflected light within the photovoltaic device or to alter the visual transmission characteristics of the laminate.

When the desired color is black, or of very dark hue, a commonly selected filler is carbon black. This filler is very effective for produce highly opaque, UV blocking films in a cost effective manner. Other desirable properties include heat conduction and reinforcement. However, when carbon black is dispersed within a polymeric matrix it can substantially increase the electrical conductivity of the matrix, and is often used for this express purpose. Even at levels of carbon black pigment that do not reduce the laminate electrical resistance to levels less than acceptable for the backsheet of a photovoltaic device, the presence of such particles can adversely effect the uniformity and control of surface treatment processes employing electrically charged particles.

The present invention surprisingly provides an effective solution to this problem while maintaining the highly opaque black color and UV protection afforded by carbon black and still allowing the film surface to be treated by electrical energy processes for improved adhesion. This present invention comprises the formation of a multilayer fluoropolymer laminate construction in which a core layer of carbon black filled fluoropolymer is combined on one or both sides with a thin surface layer free of conductive fillers. Such a film can be effectively treated with electrical processes without localized burn through. While not being bound by the explanation, it is believed that the nonconductive surface layer allows for more uniform treatment and less local concentration of surface charge that can subsequently discharge through the film to the back ground or electrode.

In one aspect, the present invention provides casting compositions useful to prepare the multilayer films of the invention by casting or coating methods.

In another aspect, the present invention provides melt processable compositions useful to prepare the multilayer films of the invention via melt processing techniques such as extrusion, coextrusion, thermal lamination, adhesive lamination, or extrusion lamination.

In another aspect, the present invention provides methods to prepare the films and multilayer films disclosed herein.

In still another aspect, the present invention provides a photovoltaic device that includes a photovoltaic component that is part of a package wherein the film or multilayer film of the invention is included. The film or mutilayer film can be in contact with the photovoltaic component, or it can be part of a laminate. Therefore, a different layer of the laminate can be in contact with the photovoltaic component with the film or multilayer film as part of the laminate or construct.

It should be understood that the multilayer films of the invention can include from 2 layers to about 12 layers of material. For example, the multilayer films can repeat layering of a first layer and a second layer, and so forth. An outer layer or two outer layers can be included in the multilayer film construction. The outer layers, for example, can be a fluoropolymer. Additionally, combinations of various layers are included herein, for example, a first layer, a second layer, a third layer differing from the first or second layers and a fourth layer which differs from the first, second or third layers, etc. This layering, again, can be repeated as needed for the application envisioned.

The present invention also provides methods to prepare the multilayered films noted throughout the specification.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed descriptions are to be regarded as illustrative in nature and not restrictive.

### DETAILED DESCRIPTION

The present invention includes various embodiments. In a first embodiment, the invention pertains to a multilayer film that includes a first layer and a second layer. The first layer is a nonconductive polymeric layer. The first layer can include one or more types of particular filler(s) that are nonconductive, e.g., does not react to a charged particle process.

The second layer includes a polymeric matrix material and a particulate filler material that is reactive to a charged particle process.

Suitable nonconductive polymers include polyolefins and copolymers thereof, such as polyethylenes, polypropylenes, polyethylene, polymethylpentene, and polybutadiene, epoxy resins, cyanate esters, polyesters, polyamides, polycarbonates, fluoropolymers, polyimides, polyacrylics, polymethacrylics, thermoplastic olefins, ethylene vinyl alcohol (EVOH), ethylene vinyl acetate (EVA), ethylene methacrylate (EMA) thermoplastic urethanes, thermoplastic silicones, ionomers, ethyl butyl acrylate (EBA), polyvinyl butyral (PVB), ethylene propylene diene M-class rubbers (EPDM) or mixtures thereof.

The phrase “fluoropolymer” is known in the art and is intended to include, for example, polytetrafluoroethylene, copolymers of tetrafluoroethylene and hexafluoropropylene, copolymers of tetrafluoroethylene and ethylene (ETFE), tetrafluoroethylene-perfluoro(alkyl vinyl ether) copolymers (e.g., tetrafluoroethylene-perfluoro(propyl vinyl ether), FEP (fluorinated ethylene propylene copolymers), polyvinyl fluoride, polyvinylidene difluoride, and copolymers of vinyl fluoride, chlorotrifluoroethylene, and/or vinylidene difluoride (i.e., VDF) with one or more ethylenically unsaturated monomers such as alkenes (e.g., ethylene, propylene, butylene, and 1-octene), chloroalkenes (e.g., vinyl chloride and tetrachloroethylene), chlorofluoroalkenes (e.g., chlorotrifluoroethylene, 3-chloropentafluoropropene, dichlorodifluoroethylene, and 1,1-dichlorofluoroethylene), fluoroalkenes (e.g., trifluoroethylene, tetrafluoroethylene (i.e., TFE), 1-hydropentafluoropropene, 2-hydropentafluoropropene, hexafluoropropylene (i.e. HFP), and vinyl fluoride), perfluoroalkoxyalkyl vinyl ethers (e.g., CF₃OCF₂CF₂CF₂OCF═CF₂); perfluoroalkyl vinyl ethers (e.g., CF₃OCF═CF₂ and CF₃C₂CF₂OCF═CF₂), perfluoro-1,3-dioxoles such as those described in U.S. Pat. No. 4,558,142 (Squire), fluorinated diolefins (e.g., perfluorodiallyl ether or perfluoro-1,3-butadiene), and combinations thereof.

The fluoropolymer can be melt-processable, for example, as in the case of polyvinylidene difluoride; copolymers of vinylidene difluoride; copolymers of tetrafluoroethylene, hexafluoropropylene, and vinylidene difluoride (e.g., those marketed by Dyneon, LLC under the trade designation “THV”); copolymers of tetrafluoroethylene and hexafluoropropylene; and other melt-processable fluoroplastics; or the fluoropolymer may not be melt-processable, for example, as in the case of polytetrafluoroethylene, copolymers of TFE and low levels of fluorinated vinyl ethers), and cured fluoroelastomers.

Useful fluoropolymers include those copolymers having HFP and VDF monomeric units.

Useful fluoropolymers also include copolymers of HFP, TFE, and VDF (i.e., THV). These polymers may have, for example, VDF monomeric units in a range of from at least about 2, 10, or 20 percent by weight up to 30, 40, or even 50 percent by weight, and HFP monomeric units in a range of from at least about 5, 10, or 15 percent by weight up to about 20, 25, or even 30 percent by weight, with the remainder of the weight of the polymer being TFE monomeric units. Examples of commercially available THV polymers include those marketed by Dyneon, LLC under the trade designations “DYNEON THV 2030G FLUOROTHERMOPLASTIC”, “DYNEON THV 220 FLUOROTHERMOPLASTIC”, “DYNEON THV 340C FLUOROTHERMOPLASTIC”, “DYNEON THV 415 FLUOROTHERMOPLASTIC”, “DYNEON THV 500A FLUOROTHERMOPLASTIC”, “DYNEON THV 610G FLUOROTHERMOPLASTIC”, or “DYNEON THV 810G FLUOROTHERMOPLASTIC”.

Other useful fluoropolymers also include copolymers of ethylene, TFE, and HFP. These polymers may have, for example, ethylene monomeric units in a range of from at least about 2, 10, or 20 percent by weight up to 30, 40, or even 50 percent by weight, and HFP monomeric units in a range of from at least about 5, 10, or 15 percent by weight up to about 20, 25, or even 30 percent by weight, with the remainder of the weight of the polymer being TFE monomeric units. Such polymers are marketed, for example, under the trade designation “DYNEON FLUOROTHERMOPLASTIC HTE” (e.g., “DYNEON FLUOROTHERMOPLASTIC HTE X 1510” or “DYNEON FLUOROTHERMOPLASTIC HTE X 1705”) by Dyneon, LLC.

Additional commercially available vinylidene difluoride-containing fluoropolymers include, for example, those fluoropolymers having the trade designations; “KYNAR” (e.g., “KYNAR 740”) as marketed by Atofina, Philadelphia, Pa.; “HYLAR” (e.g., “HYLAR 700”) as marketed by Ausimont USA, Morristown, N.J.; and “FLUOREL” (e.g., “FLUOREL FC-2178”) as marketed by Dyneon, LLC.

Commercially available vinyl fluoride fluoropolymers include, for example, those homopolymers of vinyl fluoride marketed under the trade designation “TEDLAR” by E.I. du Pont de Nemours & Company, Wilmington, Del.

Useful fluoropolymers also include copolymers of tetrafluoroethylene and propylene (TFE/P). These copolymers may have, for example, TFE monomeric units in a range of from at least about 20, 30 or 40 percent by weight up to about 50, 65, or even 80 percent by weight, with the remainder of the weight of the polymer being propylene monomeric units. Such polymers are commercially available, for example, under the trade designations “AFLAS” (e.g., “AFLAS TFE ELASTOMER FA 100H”, “AFLAS TFE ELASTOMER FA 150C”, “AFLAS TFE ELASTOMER FA 150L”, or “AFLAS TFE ELASTOMER FA 150P”) as marketed by Dyneon, LLC, or “VITON” (e.g., “VITON VTR-7480” or “VITON VTR-7512”) as marketed by E.I. du Pont de Nemours & Company, Wilmington, Del.

Useful fluoropolymers also include copolymers of ethylene and TFE (i.e., “ETFE”). These copolymers may have, for example, TFE monomeric units in a range of from at least about 20, 30 or 40 percent by weight up to about 50, 65, or even 80 percent by weight, with the remainder of the weight of the polymer being propylene monomeric units. Such polymers may be obtained commercially, for example, as marketed under the trade designations “DYNEON FLUOROTHERMOPLASTIC ET 6210J”, “DYNEON FLUOROTHERMOPLASTIC ET 6235”, or “DYNEON FLUOROTHERMOPLASTIC ET 6240J” by Dyneon, LLC.

Additionally, useful fluoropolymers include copolymers of ethylene and chlorotrifluoroethylene (ECTFE). Commercial examples include Halar 350 and Halar 500 resin from Solvay Solexis Corp. These examples are 50:50 copolymers.

Fluoropolymers are generally selected as outer layers to provide chemical resistance, electrical insulation, weatherability and/or a barrier to moisture.

The particulate filler material of the present invention includes any organic or inorganic particulate material that is reactive to a charged particle process. Suitable particulate filler materials that are reacted to charged particle process include carbon black, iron oxide, copper oxide, metallic flakes or metallic fibers such as aluminum flake or steel fibers, graphite, nickel powder, or nickel coated graphite or other conductive fillers.

While the use of a carbon black filled core is disclosed, one skilled in the art will quickly realize that this process will be equally applicable to other conductive fillers.

In a further embodiment this construction can be used with additional core compositions that could adversely affect the ability to adhesively treat the surface using charged particle processes. These can include thermally conductive fillers, metal flakes, reactive groups susceptible to degradation via electric discharge, reactive groups susceptible to reaction with added charged particle treatment gases, or components that might adversely change properties as a result of the charged particle surface treatment process as described herein.

The phrase “reactive to a charged particle process” refers to a material's physical characteristic, such as conductivity, that would cause the material to react in an adverse way under conditions where the material would degrade or damage the film/coating. For example, a variety of treatment processes are used to increase the adhesiveness of the surface. Many widely used processes involve exposing the film surface to a gas cloud that has been excited by the application of energy. A cloud of fast moving particles is produced, including electrons, ions, atoms, free radicals, molecules and other metastable species. This energetic cloud is capable of reacting with a polymer surface in a variety of ways. Specific examples of these processes include corona discharge and plasma treatment. These processes may occur in a variety of gaseous environments such as air, or inert gas mixtures. They may also include reactive gases or components that may be deposited or polymerized.

In one aspect, during corona treatment processes, localized high energy strikes can occur on the surface of a film and result in holes through the entire film where reactive particles are electrically conductive in the film. This is known in the art as “burn through”.

The present invention, surprisingly, overcomes the issue of reactivity of particles that can react under surface treatment processes that employ electrically charged particles. Such processes include, as noted above, corona treatment and plasma treatment.

The terms “particulate” and “particles” as used herein are intended to include fibers, spheres, platelets and the like.

Coating/Casting Processes

The polymer matrix material of the present invention is mixed with a first carrier liquid. The mixture may comprise a dispersion of polymeric particles in the first carrier liquid, a dispersion, i.e. an emulsion, of liquid droplets of the polymer or of a monomeric or oligomeric precursor of the polymer in the first carrier liquid or a solution of the polymer in the first carrier liquid.

The choice of the first carrier liquid is based on the particular polymeric matrix material and the form in which the polymeric matrix material is to be introduced to the casting composition of the present invention. If a solution is desired, a solvent for the particular polymeric matrix material is chosen as the carrier liquid. Suitable carriers include, for example, DMAC, NMP, or cellosolves. If a dispersion is desired, then a suitable carrier is one in which the matrix material is not soluble. An aqueous solution would be a suitable carrier liquid for a dispersion of fluoropolymer particles.

A dispersion of the particulate filler of the present invention can be in a suitable second carrier liquid in which the filler is not soluble.

Surfactants can be used prepare a dispersion in an amount effective to modify the surface tension of the second carrier liquid to enable the second carrier liquid to wet the filler particles. Suitable surfactant compounds include ionic surfactants, amphoteric, cationic and nonionic surfactants.

In one exemplary embodiment, a mixture of a polymeric matrix material and first carrier liquid and a dispersion of the filler particles in a second carrier liquid are combined to form a casting composition. Generally, the casting composition has between about 0.5 and about 60 volume percent solids (based on particles and polymeric matrix), from between about 1 to about 50 volume percent, or from between about 4 to about 30 volume percent.

The viscosity of the casting composition of the present invention can adjusted by the addition of suitable viscosity modifiers. Such modifiers include polyacrylic acid compounds, vegetable gums and cellulose based compounds. Specific examples of suitable viscosity modifiers include polyacrylic acid, methyl cellulose, polyethyleneoxide, guar gum, locust bean gum, sodium carboxymethylcellulose, sodium alginate and gum tragacanth.

To prepare a film, a layer of the composition is cast on a substrate by conventional methods, e.g. dip coating, reverse roll coating, knife-over-roll, knife-over-plate, and metering rod coating.

Suitable substrate materials include, e.g. metallic films, polymeric films or ceramic films. Specific examples of suitable substrates include stainless steel foil, polyimide films, polyester films, fluoropolymer films.

In an exemplary casting method, as detailed in U.S. Pat. No. 4,883,716, the contents of which are incorporated herein in their entirety, films are formed by casting onto a carrier belt having low thermal mass. The carrier belt is part of a casting apparatus. The carrier belt is dipped through a fluoropolymer matrix material/particular filler material dispersion in a dip pan at the base of a casting tower such that a coating of dispersion forms on the carrier belt. The coated carrier belt then passes through a metering zone in which metering bars remove excess dispersion from the coated carrier belt. After the metering zone, the coated carrier belt passes into a drying zone which is maintained at a temperature sufficient to remove the carrier liquid from the dispersion giving rise to a dried film. The carrier belt with the dried film then passes to a bake/fuse zone in which the temperature is sufficient to consolidate or fuse the fluoropolymer and particulates in the dispersion. Finally, the carrier belt passes through a cooling plenum from which it can be directed either to a subsequent dip pan to begin formation of a further layer of a subsequent film or to a stripping apparatus. The process can be repeated as many times as desired, generally providing up to 7 layers, e.g., 5 layers, 3 of which are fluoropolymer matrix/particular filler material layers and 2 are outer layers of one or more fluoropolymer(s).

In one example, the carrier liquid and processing aids, such as a surfactant and/or viscosity modifiers, are removed from the cast layer by evaporation and/or by thermal decomposition, to provide a film of the polymeric matrix material and the particulate filler. In one aspect, the particulate filled polymeric matrix composite film of the present invention is prepared by heating the cast film to evaporate the carrier liquid.

Upon removal of the carrier, and optionally other additives discussed herein, films are obtained. The films can be part of multilayer film constructs described herein.

Melt Processing

Methods to prepare the multi-layer films of the invention include cast or blown film extrusion as known in the art. Coextrusion is a particularly advantageous process for the preparation of multi-layer films of the invention. In coextrusion, the layers of the composite are brought together in a coextrusion block as melt layers and then extruded together through a die. In order to produce sheets or films, a slot die, for example, is used during extrusion.

Prior to transferring a melt into a screw extruder, the polymeric matrix and particulate are first combined and mixed well to afford a mixture that can be processed.

For example, 24:1 single screw extruders from Davis Standard Corp. can be used for the nonconductive outer layers. 30:1 single screw extruders with a Barrier Screw from Davis Standard corp. can be used for the core layer. The melts from these extruders can be combined in a multilayer feedblock and spread into a film using a single/multi manifold spreader die from Extrusion Dies Inc. For example, a 3 layer stack with a casting drum can be used as a take-off system.

The process is solvent-free and therefore advantageous from an economic and ecological standpoint. The process according to the invention permits the continuous preparation of endless plastics composites and, e.g., during a later manufacture of photovoltaic modules.

Films

The ultimate films of the invention correspond to that of the combined amount of polymeric matrix material and filler particles set forth above in regard to the casting composition, i.e. the film can comprise from about 0.25 vol. % to about 50 vol. % filler particles and from about 50 vol. % to 99.75 vol. % matrix material, in particular from about 0.25 vol. % to about 12 vol. % filler particles and from 99.75 vol. % to about 88 vol. % matrix material, more particularly from about 0.5 vol. % to about 5 vol. % filler particles and from about 99.5 vol. % to about 95 vol. % matrix material and even more particularly from about 1 vol. % to about 4 vol. % filler particles and from about 99 vol. % to about 96 vol. % matrix material.

The film of polymeric matrix material and particulate filler can be further heated to modify the physical properties of the film. This can include post cure of the film or post processing steps such as stretching, orienting, annealing, embossing and the like.

The present invention provides films having thicknesses of about 20 mils, to be economically produced. Film thicknesses are set forth herein in terms of “mils”, wherein one mil is equal to 0.001 inch.

The fluoropolymer matrix/particulate filled films of the invention have a range of transmittance of between about 0 and about 60%, in particular between about 0 and about 20% and most particularly between about 0 and about 5%.

The fluoropolymer matrix/particulate filled films of the invention have a range of dielectric strength of between about 1.5 kV/mil (DC) and about 10 kV/mil, in particular between about 3.5 kV/mil and about 10 kV/mil and most particularly between about 4 kV/mil and about 8 kV/mil

Fluoropolymers, used in particular for outer layers of the multilayer films described herein, are unique materials because they exhibit an outstanding range of properties such as high transparency, good dielectric strength, high purity, chemical inertness, low coefficient of friction, high thermal stability, excellent weathering, and UV resistance. Fluoropolymers are frequently used in applications calling for high performance in which oftentimes the combination of the above properties is required. However, due to their low surface energy, fluoropolymers are difficult to wet by most if not all non fluoropolymer materials either liquids or solids.

Subsequently, a common issue encountered with fluoropolymers is the difficult adhesion to non fluoropolymer surfaces. Again, this issue is particularly challenging for fluoropolymer composite laminates in which at least one layer is not a fluoropolymer.

It is possible that additional layers may be included between the outer nonconductive layer and the inner core to incorporate added functionality, alter mechanical properties, provide additional or environmental resistance. Any of the disclosed layers may contain common formulation additives including antioxidants, UV blockers, UV stabilizers, hindered amine stabilizers, curatives, crosslinkers, additional pigments, process aids and the like.

Surface Treatments

The present invention provides novel multilayer films and methods to prepare the multilayer films by using suitable materials in conjunction with multiple deposition of layers followed by a further optional surface treatment. In general the multilayer films of the invention include an outer layer comprising a modified fluoropolymer and an inner layer(s) described herein having the polymeric matrix/particulate film(s).

Surface modification of fluoropolymers is another way to provide a modified fluoropolymer useful in the present invention. Generally, polar functionalities are attached to the fluoropolymer surface, rendering it easier to wet and provides opportunities for chemical bonding. There are several methods to functionalize a fluoropolymer surface including plasma etch, corona treatment, chemical vapor deposition, or any combination thereof. In another embodiment, plasma etching includes reactive plasmas such as hydrogen, oxygen, acetylene, methane, and mixtures thereof with nitrogen, argon, and helium. Corona treatment can include the reactive hydrocarbon vapors such as ketones, e.g., acetone, alcohols, p-chlorostyrene, acrylonitrile, propylene diamine, anhydrous ammonia, styrene sulfonic acid, carbon tetrachloride, tetraethylene pentamine, cyclohexyl amine, tetra isopropyl titanate, decyl amine, tetrahydrofuran, diethylene triamine, tertiary butyl amine, ethylene diamine, toluene-2,4-diisocyanate, glycidyl methacrylate, triethylene tetramine, hexane, triethyl amine, methyl alcohol, vinyl acetate, methylisopropyl amine, vinyl butyl ether, methyl methacrylate, 2-vinyl pyrrolidone, methylvinylketone, xylene or mixtures thereof.

Some techniques use a combination of steps including one of these methods. For example, surface activation can be accomplished by plasma or corona in the presence of an excited gas species. For the surface may be modified by corona treatment in the presence of a solvent gas such as acetone.

Not to be limited by theory, the method has been found to provide strong interlayer adhesion between a modified fluoropolymer and a non fluoropolymer interface (or a second modified fluoropolymer). In one way, a fluoropolymer and a non fluoropolymer shape are each formed separately. Subsequently, the fluoropolymer shape is surface treated by the treatment process described in U.S. Pat. Nos. 3,030,290, 3,255,099, 3,274,089, 3,274,090, 3,274,091, 3,275,540, 3,284,331, 3,291,712, 3,296,011, 3,391,314, 3,397,132, 3,485,734, 3,507,763, 3,676,181, 4,549,921 and 6,726,979, the teachings of which are incorporated herein in their entirety for all purposes. Then, the resultant modified fluoropolymer and non fluoropolymer shapes are contacted together for example by heat lamination to form a multilayer film. Additionally, the multilayer film can be submitted to a UV radiation with wavelengths in the UVA; UVB and/or UVC range.

In one aspect, the surface of the fluoropolymer substrate is treated with a corona discharge where the electrode area was flooded with acetone, tetrahydrofuran methylethyl ketone, ethyl acetate, isopropyl acetate or propyl acetate vapors. In another aspect, the surface of the fluoropolymer substrate is treated with corona in a nitrogen atmosphere.

Corona discharge is produced by capacitative exchange of a gaseous medium which is present between two spaced electrodes, at least one of which is insulated from the gaseous medium by a dielectric barrier. Corona discharge is somewhat limited in origin to alternating currents because of its capacitative nature. It is a high voltage, low current phenomenon with voltages being typically measured in kilovolts and currents being typically measured in milliamperes. Corona discharges may be maintained over wide ranges of pressure and frequency. Pressures of from 0.2 to 10 atmospheres generally define the limits of corona discharge operation and atmospheric pressures generally are preferred. Frequencies ranging from 20 Hz to 100 MHz can conveniently be used: in particular ranges are from 500 Hz, especially 3000 Hz to 10 MHz.

When dielectric barriers are employed to insulate each of two spaced electrodes from the gaseous medium, the corona discharge phenomenon is frequently termed an electrodeless discharge, whereas when a single dielectric barrier is employed to insulate only one of the electrodes from the gaseous medium, the resulting corona discharge is frequently termed a semi-corona discharge. The term “corona discharge” is used throughout this specification to denote both types of corona discharge, i.e. both electrodeless discharge and semi-corona discharge.

All details concerning the corona discharge treatment procedure are provided in a series of U.S. Patents assigned to E. I. du Pont de Nemours and Company, USA, described in expired U.S. Pat. No. 3,676,181, and Saint-Gobain Performance Plastics Corporation U.S. Pat. No. 6,726,979, the teachings of which are incorporated herein in their entirety for all purposes. An example of the proposed technique may be found in U.S. Pat. No. 3,676,181 (Kowalski). The atmosphere for the enclosed treatment equipment is a 20% acetone (by volume) in nitrogen and is continuous. The outer layer of a constantly fed multilayer film or particulate filled film, for example, is subjected to between 0.15 and 2.5 Watt hrs per square foot of the film/sheet surface. The fluoropolymer can be treated on both sides of the film/shape to increase the adhesion. The material can then be placed on a non-siliconized release liner for storage. Materials treated by these methods can last more than 1 year without significant loss of surface wettability, cementability and adhesion.

In another aspect, the surface of the fluoropolymer is treated with a plasma. The phrase “plasma enhanced chemical vapor deposition” (PECVD) is known in the art and refers to a process that deposits thin films from a gas state (vapor) to a solid state on a substrate. There are some chemical reactions involved in the process, which occur after creation of a plasma of the reacting gases. The plasma is generally created by RF (AC) frequency or DC discharge between two electrodes where in between the substrate is placed and the space is filled with the reacting gases. A plasma is any gas in which a significant percentage of the atoms or molecules are ionized, resulting in reactive ions, electrons, radicals and UV radiation.

The vacuum chamber contains two conducting electrodes which are placed opposite each other in the chamber within 3 inches, preferably within 2 inches, more preferably within 1 inch or less of each other. One electrode is connected to an RF power supply and the other electrode is connected to a ground. Alternatively, a DC ion source may be used for ignition of the plasma. The polymeric substrate is placed in contact with the ground electrode.

The vacuum chamber is further connected to a source of gasified liquid that include, acetone, tetrahydrofuran methylethyl ketone, ethyl acetate, isopropyl acetate or propyl acetate or a mixtures thereof. The connections to the gases are typically through mass flow meters. In one configuration, the RF-driven electrode is a shower head electrode, used for the injection of the process gas. The shower head concept leads to a very good uniformity of gas injection on the whole surface.

After a base chamber pressure is reached, hydrogen can be first introduced, followed by a second gas (or combination of gases) into the chamber in a various ratios. For this first step (pre-treatment), hydrogen only is introduced, with the parameters specified above. There is generally no second gas, but, instead of hydrogen, it is possible to use argon, oxygen, ammonia (NH₃), or helium as the pretreatment gas. Mixtures of one or more of these gases are within the scope of the present invention.

The plasma can be ignited by the RF power supply producing about a 40 KHz to about a 2.45 GHz frequency. Alternatively, a DC ion source may be used to ignite the plasma. The power is between about 0.1 to about 1 W/cm², of forward power and the polymeric surface is exposed to the plasma for about 120 seconds, preferably exposure is for approximately 60 seconds. The reaction is conducted at room temperature.

Generally, the surface is treated with a plasma that is tetrahydrofuran methylethyl ketone, ethyl acetate, isopropyl acetate, propyl acetate or mixtures thereof. The substrate is generally treated for about 10 to about 300 seconds, in particular from about 20 to about 120 seconds, more particularly about 60 seconds.

In another aspect, the surface may be treated with plasma according to the technique of U.S. Pat. No. 6,118,218 (Yializis) using steady-state glow-discharge plasma at atmospheric pressure. The plasma can be ignited by an RF power supply at about 150 kHz. The electrode pair can be a hollow ceramic chamber and a ceramic roll. Gases introduced into the hollow chamber electrode can include hydrogen, helium, argon, nitrogen, oxygen, carbon dioxide, ammonia, acetylene or mixtures thereof. The substrate is generally treated at about 15 to 200 feet per minute, at a supplied power of from about 2 to 10 kW.

Generally the multilayer film has a thickness of between about 0.2 mil to about 20 mils, between about 1 mil (0.001 inch) and about 10 mils, more particularly between about 2 mils and about 5 mils and in particular between about 0.5 and about 2 mils.

The multilayer films of the invention can be used to protect, in particular, electronic components from moisture, weather, heat, radiation, physical damage and/or insulate the component. Examples of optoelectronic components include, but are not limited to, packaging for crystalline-silicon based photovoltaic modules, amorphous silicon, CIGS, DSC, OPV or CdTe based thin photovoltaic modules, OLEDS, LEDs, LCDs, printed circuit boards, flexible displays and printed wiring boards.

In the specification and in the claims, the terms “including” and “comprising” are open-ended terms and should be interpreted to mean “including, but not limited to . . . ” These terms encompass the more restrictive terms “consisting essentially of and “consisting of.”

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

The following paragraphs enumerated consecutively from 1 through 32 provide for various aspects of the present invention. In one embodiment, in a first paragraph (1), the present invention provides a multilayer film comprising: a first layer and a second layer, wherein the first layer is a nonconductive layer and the second layer comprises: a polymeric matrix material; and a particulate filler material that is reactive to a charged particle process, wherein the multilayer film has a dielectric strength of at least 3.5 kV/mil.

2. The film of paragraph 1, wherein the first nonconductive layer can be a polyolefin and copolymers thereof, epoxy resin, a cyanate ester, a polyester, a polyamide, a polycarbonate, a fluoropolymer, a polyimide, a polyacrylic, a polymethacrylic, a thermoplastic olefin, ethylene vinyl alcohol (EVOH), ethylene vinyl acetate (EVA), ethylene methacrylate (EMA) thermoplastic urethane, a thermoplastic silicone, an ionomer, ethyl butyl acrylate (EBA), polyvinyl butyral (PVB), an ethylene propylene diene M-class rubber (EPDM) or mixtures thereof.

3. The film of either of paragraphs 1 or 2, wherein the fluoropolymer is selected from polytetrafluoroethylene, polyvinylidenefluoride, polychlorotrifluoroethlylene, polyvinylfluoride, tetrafluoroethylene/hexafluoropropylene/ethylene copolymer, chlorotrifluoroethylene/vinylidenefluoride copolymer, chlorotrifluoroethylene/hexafluoropropylene, chlorotrifluoroethylene/ethylene copolymers, ethylene/trifluoroethylene copolymers, ethylene/tetrafluoroethylene copolymers, fluorinated ethylene/propylene copolymers or mixtures thereof.

4. The film of any of paragraphs 1 through 3, wherein the filler particles compromise carbon black, iron oxide, copper oxide, metallic flakes, or nickel coated graphite.

5. The film of any of paragraphs 1 through 4, wherein the polymeric matrix material is a polyolefin and copolymers thereof, epoxy resin, a cyanate ester, a polyester, a polyamide, a polycarbonate, a fluoropolymer, a polyimide, a polyacrylic, a polymethacrylic, a thermoplastic olefin, ethylene vinyl alcohol (EVOH), ethylene vinyl acetate (EVA), ethylene methacrylate (EMA) thermoplastic urethane, a thermoplastic silicone, an ionomer, ethyl butyl acrylate (EBA), polyvinyl butyral (PVB), an ethylene propylene diene M-class rubber (EPDM) or mixtures thereof.

6. The film of paragraph 5, wherein the fluoropolymer is an ETFE or an FEP.

7. The film of any of paragraphs 1 through 6, wherein the first nonconductive layer is modified by a charged particle process.

8. The film of paragraph 7, wherein the charged particle process is corona discharge or plasma treatment.

9. The film of paragraph 8, wherein the corona treatment is conducted in the presence of a solvent atmosphere.

10. The film of paragraph 9, wherein the solvent atmosphere is a ketone.

11. The film of any of paragraphs 1 through 10, further comprising a third nonconductive layer such that the first nonconductive layer and third nonconductive layer enclose the second layer.

12. The film of paragraph 11, wherein the third nonconductive layer can be a polyolefin and copolymers thereof, epoxy resin, a cyanate ester, a polyester, a polyamide, a polycarbonate, a fluoropolymer, a polyimide, a polyacrylic, a polymethacrylic, a thermoplastic olefin, ethylene vinyl alcohol (EVOH), ethylene vinyl acetate (EVA), ethylene methacrylate (EMA) thermoplastic urethane, a thermoplastic silicone, an ionomer, ethyl butyl acrylate (EBA), polyvinyl butyral (PVB), an ethylene propylene diene M-class rubber (EPDM) or mixtures thereof.

13. The film of either of paragraphs 11 or 12, wherein the fluoropolymer is selected from polytetrafluoroethylene, polyvinylidenefluoride, polychlorotrifluoroethlylene, polyvinylfluoride, tetrafluoroethylene/hexafluoropropylene/ethylene copolymer, chlorotrifluoroethylene/vinylidenefluoride copolymer, chlorotrifluoroethylene/hexafluoropropylene, chlorotrifluoroethylene/ethylene copolymers, ethylene/trifluoroethylene copolymers, ethylene/tetrafluoroethylene copolymers, fluorinated ethylene/propylene copolymers or mixtures thereof.

14. The film of any of paragraphs 11 through 13, wherein the first nonconductive layer is modified by a charged particle process.

15. The film of any of paragraphs 11 through 14, wherein the second nonconductive layer is modified by a charged particle process.

16. The film of either of paragraphs 14 or 15, wherein the charged particle process is corona discharge or plasma treatment.

17. The film of paragraph 16, wherein the corona treatment is conducted in the presence of a solvent atmosphere.

18. The film of paragraph 17, wherein the solvent atmosphere is a ketone.

19. A photovoltaic device comprising: a photovoltaic component and any of the multilayer films of paragraphs 1 through 18, wherein the photovoltaic component and multilayer film are packaged together.

20. A process to prepare a multilayer film comprising the steps: coating a casting composition onto a support, the casting composition comprising: a carrier; a polymeric matrix material; and a particulate filler material that is reactive to a charged particle process.

21. The method of paragraph 20, further comprising the step: contacting the charged particle filled layer with a second casting composition, wherein the second casting composition comprises: a carrier; and a nonconductive polymer, thereby providing a multilayer film.

22. The method of paragraph 21, further comprising the step: contacting the charged particle filled layer with a third casting composition, wherein the third casting composition comprises: a carrier; and a nonconductive polymer, thereby providing a 3 layer multilayer film wherein the charged particle layer is in between the first and third nonconductive layers.

23. The method of any of either of paragraphs 21 or 22, further comprising the step of: subjecting a nonconductive layer to a charged particle process.

24. The method of paragraph 23, wherein the charged particle process is corona discharge or plasma treatment.

25. The method of paragraph 24, wherein the corona treatment is conducted in the presence of a solvent atmosphere.

26. The method of paragraph 25, wherein the solvent atmosphere is a ketone.

27. A process to prepare a multilayer film comprising the steps: combining a polymeric matrix material; a particulate filler material that is reactive to a charged particle process, and coextruding a nonconductive polymer as a second layer adjacent to the charged particle layer.

28. The process of paragraph 27, further comprising coextruding a nonconductive third layer adjacent to the charged particle layer.

29. The process of either of paragraphs 27 or 28, further comprising the step of subjecting a nonconductive layer to a charged particle process.

30. The method of paragraph 29, wherein the charged particle process is corona discharge or plasma treatment.

31. The method of paragraph 30, wherein the corona treatment is conducted in the presence of a solvent atmosphere.

32. The method of paragraph 31, wherein the solvent atmosphere is a ketone.

The invention will be further described with reference to the following non-limiting Examples. It will be apparent to those skilled in the art that many changes can be made in the embodiments described without departing from the scope of the present invention. Thus the scope of the present invention should not be limited to the embodiments described in this application, but only by embodiments described by the language of the claims and the equivalents of those embodiments. Unless otherwise indicated, all percentages are by weight.

### Examples

### Carbon Black Masterbatch

ETFE210 from DuPont having an MFR of 20 was blended with carbon black in a high shear blender at a temperature suitable to obtain a desirable dispersion. The loading weight was approximately 4%.

Measurement Methods

Dielectric breakdown strength measurements were measured according to ASTM D149. Films were placed between circular electrodes having a diameter of 0.25 inch. A ramped DC voltage was then applied at a constant ramp rate (typically 500V/s) starting from zero volts. The voltage at which a burn through of the film thickness is observed was reported as the dielectric breakdown voltage.

Light transmission was measured according to ASTM E424. A Perkin Elmer LAMDA40 UV spectrometer was mounted with an integrated sphere. The wavelength scan range was 200 nm-1100 nm. Background correction scan was performed leaving the transmittance port empty and reflectance standard in the reflectance port. Films were then loaded in the transmittance port of the accessory and % total transmittance (diffuse+regular transmittance) was determined.

Tensile properties were measured according to ASTM D639 with a test speed of 2 inches/min.

Average peel strength was measured by a 180° T peel test method according to ASTM D903 using a travel speed of 12 inches/min.

Co-Extrusion Trial 1

A 1 mil three layer film was obtained by co-extruding two outer layers made from Daikin EP521 resin (layers A & C) and an inner layer B containing carbon black from the masterbatch described in example 1. The multilayer film was formed as follows. The carbon black concentrate was mixed with EP521 in a bag to give the layer B (master batch content shown in the table below), the mixture was then charged into a hopper feeding a 24:1 single screw extruder fitted with a screw having mixing elements and feeding channel B of an ABC feedblock. Unfilled EP521 resin was charged into two separate hoppers each connected to a 24:1 single screw extruder feeding the A and C channel of an ABC feedblock. The feedblock was further connected to a 8″ coat hanger type flat film die. Extruder heaters corresponding to the compression zone, clamps, melt pipes and die temperatures were set at 560 F. Extruder screw speeds were varied to obtain different layer ratios. Light transmission and dielectric breakdown strength of the co-extruded films were then measured as shown in Table 1. (Ratio layer % is determined as a function of total thickness of the film.)

TABLE 1

| | | Ratio | | | Light transmission | Dielectric |
|---|---|---|---|---|---|---|
| | Layer B MB | layer B | Ratio layer | Light transmission | visible/near IR | breakdown strength |
| Examples | content (%) | (%) | A&C (%) | UV (200-400 nm) % | (400-1100 nm) % | (kV/mil) |
| A1 | 50 | 30 | 35 | 2.80 (+/−0.17) | 9.75 (+/−0.54) | 6.77 (+/−0.47) |
| A2 | 50 | 60 | 20 | 0.40 (+/−0.04) | 0.55 (+/−0.06) | 5.52 (+/−0.30) |
| A3 | 100 | 30 | 35 | 0.9 (+/−0.06) | 4.00 (+/−0.21) | 5.47 (+/−1.02) |
| A4 | 100 | 60 | 20 | 0.4 (+/−0.04) | 1.00 (+/−0.11) | 4.43 (+/−0.36) |
| Ref 1 | 0 | 100 | 0 | 89.75 (+/−4.22) | 95.63 (+/−0.52) | 7.58 (+/−1.05) |
| Ref 2 | 50 | 100 | 0 | 0.35 (+/−0.3) | 0.49 (+/−0.04) | 2.57 (+/−0.21) |

(+/− value is standard deviation)

It was found that it is possible to obtain a low light transmission while maintaining a high resistance to dielectric failure when co-extruding an inner layer filled with conductive filler and outer layer made from an unfilled ETFE resin. High dielectric breakdown strength is desirable for a photovoltaic backsheet application.

Co-Extrusion Trial and C-Treatment

A 1 mil three layer film was co-extruded with a similar set up described in the example above. Three 30/1 extruder were used with a 60 inches multi manifold die. Extruder heaters corresponding to the compression zone, clamps, melt pipes and die temperatures were set at 581 F. Extruder output was monitored during the process. The film was further surface treated by corona in presence of acetone vapors. The film was passed beneath the corona electrodes at a distance of about 1 mm at a speed of about 100 feet per minute, using a power source of 8 kW. Light transmission and dielectric breakdown strength was then measured and are reported in Table 2 below.

TABLE 2

| | Output | Output | Output | Light | Light transmission | Dielectric | Elongation at | Elongation at |
|---|---|---|---|---|---|---|---|---|
| | extruder A | extruder B | extruder C | transmission UV | visible/near IR | breakdown | break average (%) | break (%) transverse |
| Examples | (lbs/hr) | (lbs/hr) | (lbs/hr) | (w200-400 nm) % | (400-1100 nm) % | strength (kV/mil) | machine direction | direction |
| B1 | 29.8 | 76.3 | 22.4 | 0.20 (+/−0.20) | 3.12 (+/−1.44) | 5.40 (+/−0.51) | 278 | 254 |
| B2 | 51.4 | 45.7 | 34.7 | 1.8 (+/−1.5) | 9.30 (+/−4.24) | 6.34 (+/−0.43) | 524 | 551 |

(+/− value is standard deviation)

Films B1 and B2, surface modified by the c-treatment process, maintained a good appearance and did not exhibit burn through defects.

The examples provide that films having particles that are otherwise susceptible to charged particle processes can be prepared when a nonconductive layer is applied thereto. Furthermore, it is important to note that higher dielectric strengths are obtained by this multilayer construction. For example, the multilayer films of the invention have dielectric strengths of at least 3 kV/mil, more particularly at least 5 kV/mil and even more particularly at least 7 kV/mil or greater. In contrast, unfilled multilayer films have a dielectric strength of less than 3 kV/mil, e.g., approximately 2.5 kV/mil.

Adhesion to EVA

An EVA resin having a vinyl acetate suitable for a photovoltaic encapsulant application was compounded with a: peroxide, antioxidant, UV absorber, UV stabilizer and silane coupling agent. A 26 mil film was extruded from the EVA compound at approximately 80-90° C. using a 30:1 single screw extruder mounted with a 8″ coat hanger type flat film die.

A film structure was formed comprising the following layer stacked on top of each other: laminate 1 (L1): EVA1 film/B1/EVA2/reinforcing layer; Laminate 2 (L2): EVA1/B2/EVA2/reinforcing layer wherein EVA1 and EVA2 films are identical and made from the composition and method described in example above. B1 and B2 are the films noted above. The reinforcing layer made of either B1 or B2 film. The film structure was further laminated in a PV laminator at a temperature of 155° C. to bond each layer together. Adhesion at the interface between either film B1 or B2 and EVA2 was measured by a T-peel test. The results are reported in the Table 3 below:

TABLE 3

| Laminate structure | Average peel strength (N/inch) |
|---|---|
| L1 | >92.7 |
| L2 | >95.2 |

Both laminates experienced cohesive failure. Adhesion of either B1 or B2 film with a photovoltaic encapsulant was strong.

Although the present invention has been described with reference to preferred embodiments, persons skilled in the art will recognize that changes may be made in form and detail without departing from the spirit and scope of the invention. All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

What is claimed is:

1. A multilayer film comprising:
a first layer and a second layer, wherein the first layer is a nonconductive layer and the second layer comprises:
a polymeric matrix material; and
a particulate filler material that is reactive to a charged particle process, wherein the multilayer film has a dielectric strength of at least 3.5 kV/mil.

2. The film of claim 1, wherein the first nonconductive layer can be a polyolefin and copolymers thereof, epoxy resin, a cyanate ester, a polyester, a polyamide, a polycarbonate, a fluoropolymer, a polyimide, a polyacrylic, a polymethacrylic, a thermoplastic olefin, ethylene vinyl alcohol (EVOH), ethylene vinyl acetate (EVA), ethylene methacrylate (EMA) thermoplastic urethane, a thermoplastic silicone, an ionomer, ethyl butyl acrylate (EBA), polyvinyl butyral (PVB), an ethylene propylene diene M-class rubber (EPDM) or mixtures thereof.

3. The film of claim 2, wherein the fluoropolymer is selected from polytetrafluoroethylene, polyvinylidenefluoride, polychlorotrifluoroethlylene, polyvinylfluoride, tetrafluoroethylene/hexafluoropropylene/ethylene copolymer, chlorotrifluoroethylene/vinylidenefluoride copolymer, chlorotrifluoroethylene/hexafluoropropylene, chlorotrifluoroethylene/ethylene copolymers, ethylene/trifluoroethylene copolymers, ethylene/tetrafluoroethylene copolymers, fluorinated ethylene/propylene copolymers or mixtures thereof.

4. The film of claim 3, wherein the filler particles compromise carbon black, iron oxide, copper oxide, metallic flakes, or nickel coated graphite.

5. The film of claim 4, wherein the polymeric matrix material is a polyolefin and copolymers thereof, epoxy resin, a cyanate ester, a polyester, a polyamide, a polycarbonate, a fluoropolymer, a polyimide, a polyacrylic, a polymethacrylic, a thermoplastic olefin, ethylene vinyl alcohol (EVOH), ethylene vinyl acetate (EVA), ethylene methacrylate (EMA) thermoplastic urethane, a thermoplastic silicone, an ionomer, ethyl butyl acrylate (EBA), polyvinyl butyral (PVB), an ethylene propylene diene M-class rubber (EPDM) or mixtures thereof.

6. The film of claim 5, wherein the fluoropolymer is an ETFE or an FEP.

7. The film of claim 6, wherein the first nonconductive layer is modified by a charged particle process.

8. The film of claim 7, wherein the charged particle process is corona discharge or plasma treatment.

9. The film of claim 8, wherein the corona treatment is conducted in the presence of a solvent atmosphere.

10. The film of claim 9, wherein the solvent atmosphere is a ketone.

11. The film of claim 1, further comprising a third nonconductive layer such that the first nonconductive layer and third nonconductive layer enclose the second layer.

12. The film of claim 11, wherein the third nonconductive layer can be a polyolefin and copolymers thereof, epoxy resin, a cyanate ester, a polyester, a polyamide, a polycarbonate, a fluoropolymer, a polyimide, a polyacrylic, a polymethacrylic, a thermoplastic olefin, ethylene vinyl alcohol (EVOH), ethylene vinyl acetate (EVA), ethylene methacrylate (EMA) thermoplastic urethane, a thermoplastic silicone, an ionomer, ethyl butyl acrylate (EBA), polyvinyl butyral (PVB), an ethylene propylene diene M-class rubber (EPDM) or mixtures thereof.

13. The film of claim 12, wherein the fluoropolymer is selected from polytetrafluoroethylene, polyvinylidenefluoride, polychlorotrifluoroethlylene, polyvinylfluoride, tetrafluoroethylene/hexafluoropropylene/ethylene copolymer, chlorotrifluoroethylene/vinylidenefluoride copolymer, chlorotrifluoroethylene/hexafluoropropylene, chlorotrifluoroethylene/ethylene copolymers, ethylene/trifluoroethylene copolymers, ethylene/tetrafluoroethylene copolymers, fluorinated ethylene/propylene copolymers or mixtures thereof.

14. The film of claim 13, wherein the first nonconductive layer is modified by a charged particle process.

15. The film of claim 14, wherein the second nonconductive layer is modified by a charged particle process.

16. The film of claim 15, wherein the charged particle process is corona discharge or plasma treatment.

17. The film of claim 16, wherein the corona treatment is conducted in the presence of a solvent atmosphere.

18. The film of claim 17, wherein the solvent atmosphere is a ketone.

19. An optoelectric device comprising:
a optoelectric component and the multilayer film of claim 1, wherein the optoelectric component and multilayer film are packaged together.

20. The optoelectronic device of claim 19, wherein the film is a backsheet to the optoelectronic component.

21. A process to prepare a multilayer film comprising the steps:
coating a casting composition onto a support, the casting composition comprising:
a carrier;
a polymeric matrix material; and
a particulate filler material that is reactive to a charged particle process.

22. The method of claim 21, further comprising the step:
contacting the charged particle filled layer with a second casting composition, wherein the second casting composition comprises:
a carrier; and
a nonconductive polymer, thereby providing a multilayer film.

23. The method of claim 22, further comprising the step:
contacting the charged particle filled layer with a third casting composition, wherein the third casting composition comprises:
a carrier; and
a nonconductive polymer, thereby providing a 3 layer multilayer film wherein the charged particle layer is in between the first and third nonconductive layers.

24. The method of claim 22, further comprising the step of:
subjecting a nonconductive layer to a charged particle process.

25. The method of claim 24, wherein the charged particle process is corona discharge or plasma treatment.

26. The method of claim 25, wherein the corona treatment is conducted in the presence of a solvent atmosphere.

27. The method of claim 26, wherein the solvent atmosphere is a ketone.

28. A process to prepare a multilayer film comprising the steps:
combining a polymeric matrix material;
a particulate filler material that is reactive to a charged particle process, and
coextruding a nonconductive polymer as a second layer adjacent to the charged particle layer.

29. The process of claim 28, further comprising coextruding a nonconductive third layer adjacent to the charged particle layer.

30. The process of claim 29, further comprising the step of subjecting a nonconductive layer to a charged particle process.

31. The method of claim 30, wherein the charged particle process is corona discharge or plasma treatment.

32. The method of claim 31, wherein the corona treatment is conducted in the presence of a solvent atmosphere.

33. The method of claim 32, wherein the solvent atmosphere is a ketone.
